(19) United States
(12) Patent Application Publication
(10) Pub. No.: US 2019/0198010 A1
(43) Pub. Date: Jun. 27, 2019

(54) SPEECH SYNTHESIS SYSTEM

(71) Applicant: Onkyo Corporation, Osaka (JP)

(72) Inventor: Yusuke KONDO, Osaka (JP)

(21) Appl. No.: 16/213,425

(22) Filed: Dec. 7, 2018

(30) Foreign Application Priority Data
Dec. 22, 2017 (JP) 2017-246568

(51) Int. Cl. G10L 13/08; G10L 13/04

(52) U.S. Cl. CPC G10L 13/08; G10L 13/043

(57) ABSTRACT

A speech synthesis system configured to: obtain phoneme information from recorded voice data; and store the obtained phoneme information and user contact information in association with each other, wherein a user terminal acquires and stores the storedphoneme information and user contact information, and reads received text based on phoneme information which corresponds to user contact information of another user terminal when receiving text from the other user terminal.

### CROSS-REFERENCE TO RELATED APPLICATIONS

This application claims priority to Japanese Application No. 2017-246568, filed Dec. 22, 2017, the entire contents of which are incorporated herein by reference.

### FIELD

The present disclosure relates to a speech synthesis system which performs speech synthesis.

### BACKGROUND

A speech synthesis system which performs speech synthesis converts text to be read into speech (TTS: Text To Speech) and outputs the converted speech. In JP 2003-044072 A, an invention which judges a category to which a document to be read belongs, performs speech reading setting which corresponds to the category of judge result to the document to be read, and performs speech reading based on document data to be read which corresponds to the document to be read and speech reading setting is disclosed. For example, when a category of a document to be read is news, reading of the document to be read is performed by voice of an announcer.

For example, when a mail from a friend of a user is received, if the mail is read by voice of the friend, the user can be enjoyed.

### SUMMARY OF THE DISCLOSURE

According to one aspect of the disclosure, there is provided a speech synthesis system configured to: obtain phoneme information from recorded voice data; and store the obtained phoneme information and user contact information in association with each other, wherein a user terminal acquires and stores the stored phoneme information and user contact information, and reads received text based on phoneme information which corresponds to user contact information of another user terminal when receiving text from the other user terminal.

### BRIEF DESCRIPTION OF THE DRAWINGS

FIG. 1 is a block diagram illustrating a constitution of a speech synthesis system according to an embodiment of the present disclosure.

FIG. 2 is a diagram for describing operation in speech synthesis.

FIG. 3 is a diagram for describing operation in speech synthesis.

FIG. 4 is a diagram for describing operation in speech synthesis.

FIG. 5 is a diagram for describing operation in speech synthesis.

### DETAILED DESCRIPTION OF THE PREFERRED EMBODIMENTS

An objective of the present disclosure is to provide an interesting speech synthesis system for a user.

First, speech synthesis technology which is related to the present embodiment is described. For example, a user speaks against a speaker device which has a voice recognition function and voice of the user is recorded. Characteristics of the recorded voice data are stored as phoneme information. In TTS (Text To Speech), speech which captures characteristics of voice of the user is spoken by using the phoneme information.

Next, sharing technology of contact information is described. Contact information such as a phone book of the user is managed by a server with a local (terminal). A terminal of a user A can download information of a user B which is managed by the same server from the server. The terminal of the user B can refer a thumbnail image of the user B based on the information of the user B.

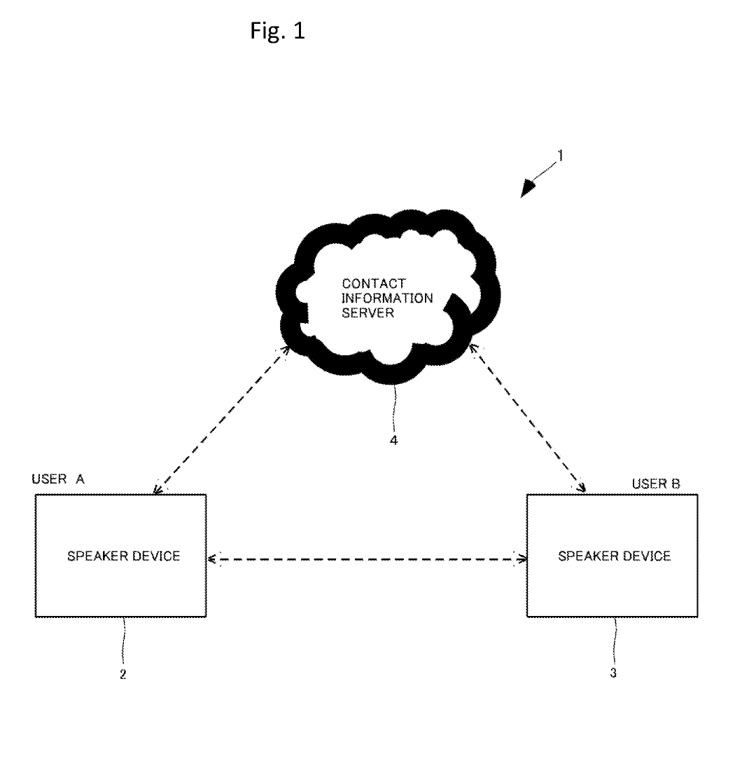

An embodiment of the present disclosure is described below. FIG. 1 is a block diagram illustrating a constitution of a speech synthesis system according to an embodiment of the present disclosure. The speech synthesis system 1 is composed of speaker devices 2 and 3, and a contact information server 4. The speaker device 2 (user terminal) is a terminal which is owned by a user A. The speaker device 3 (user terminal) is a terminal which is owned by a user B. Each of the speaker devices 2 and 3 includes an SoC (System on Chip) (controller), a microphone, a speaker and so on. The contact information server 4 stores user contact information (user name, telephone number, mail address, user ID and so on) including the user A who is an owner of the speaker device 2 and the user B who is an owner of the speaker device 3.

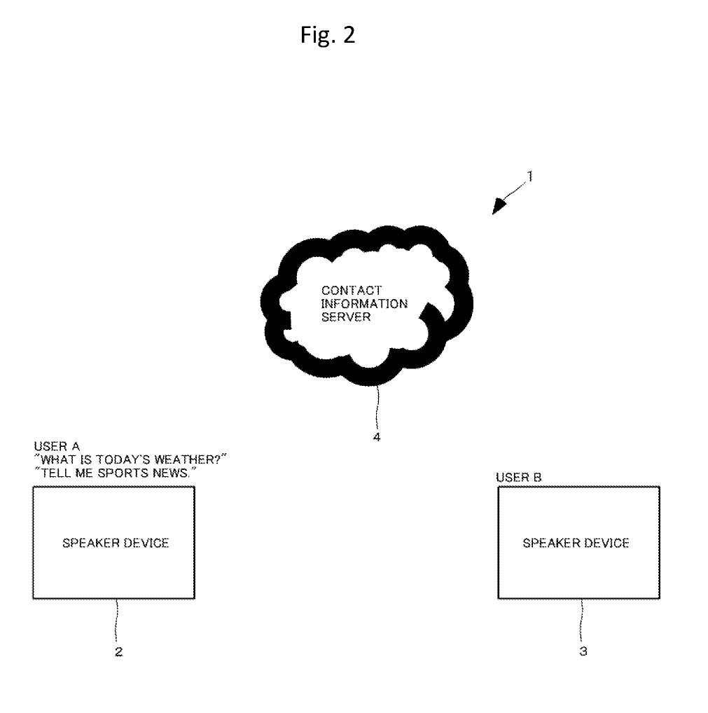

The speaker device 2 composes a voice recognition system which performs voice recognition, and as illustrated in FIG. 2, for example, the user A speaks “What is today's weather?” and “Tell me sports news” against the speaker device 2. The SoC records voice data which is spoken by the user invoice recognition. The SoC obtains phoneme information from the recorded voice data. Therefore, the voice data which is recorded by the SoC is voice data which is spoken against the speaker device 2 in voice recognition. As described above, voice that the user A generally uses is utilized and phoneme information is obtained.

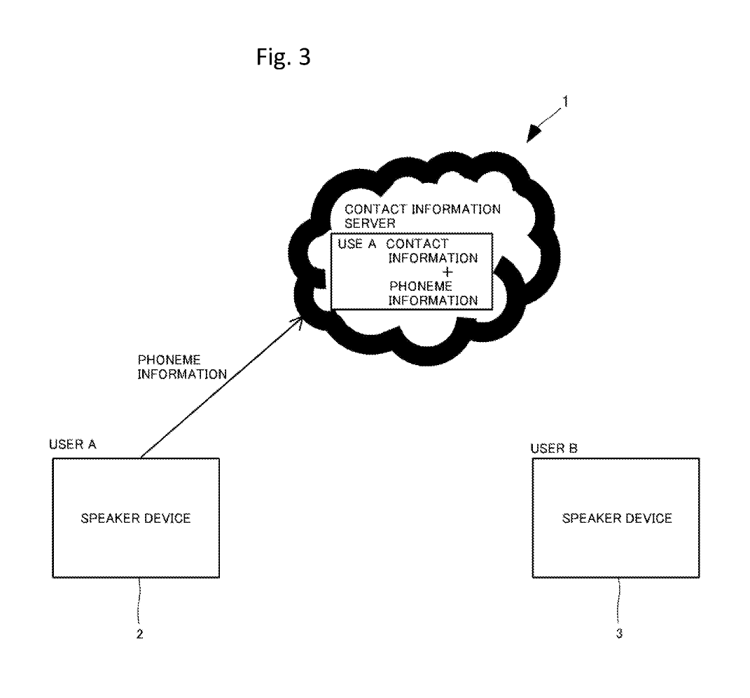

As illustrated in FIG. 3, the SoC sends the obtained phoneme information of the user A to the contact information server 4. The contact information server 4 receives (obtains) the phoneme information of the user A which is sent from the speaker device 2. The contact information server 4 stores the received phoneme information of the user A and the contact information of the user A in association with each other. In this manner, the phoneme information of the user A is registered in the contact information server 4. In the present embodiment, phoneme information is obtained by the speaker device 2 and is sent to the contact information server 4. The voice data may be sent to the contact information server 4, and the contact information server 4 may obtain phoneme information from the voice data.

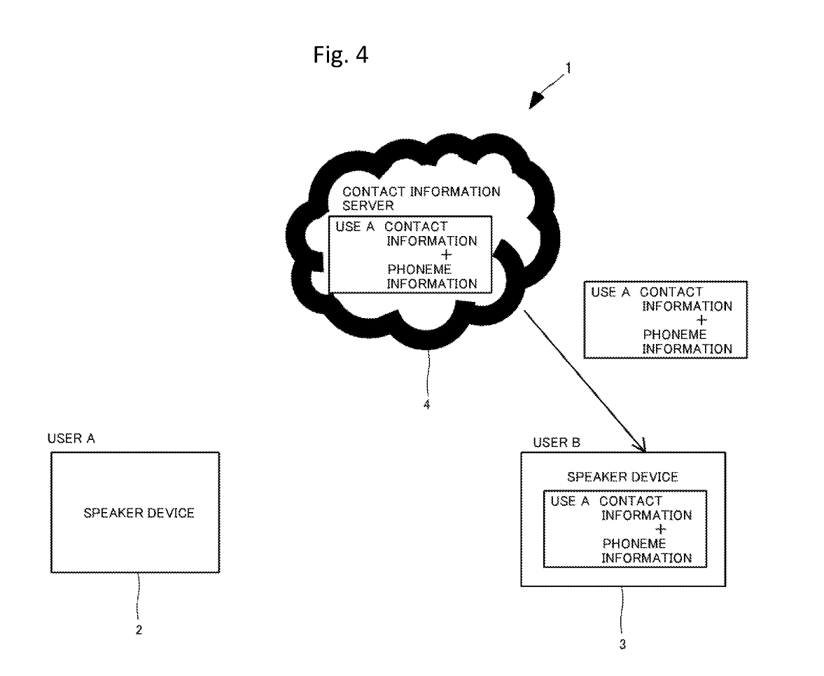

As illustrated in FIG. 4, the SoC of the speaker device 3 which is owned by the user B downloads (obtains) the contact information and the phoneme information of the user A from the contact information server 4 and stores them based on the user operation. Herein, the contact information server 4 stores the phoneme information and the user contact information in association with each other. Multiple pieces of phoneme information and user contact information are stored in multiple speaker devices and are shared by the multiple speaker devices.

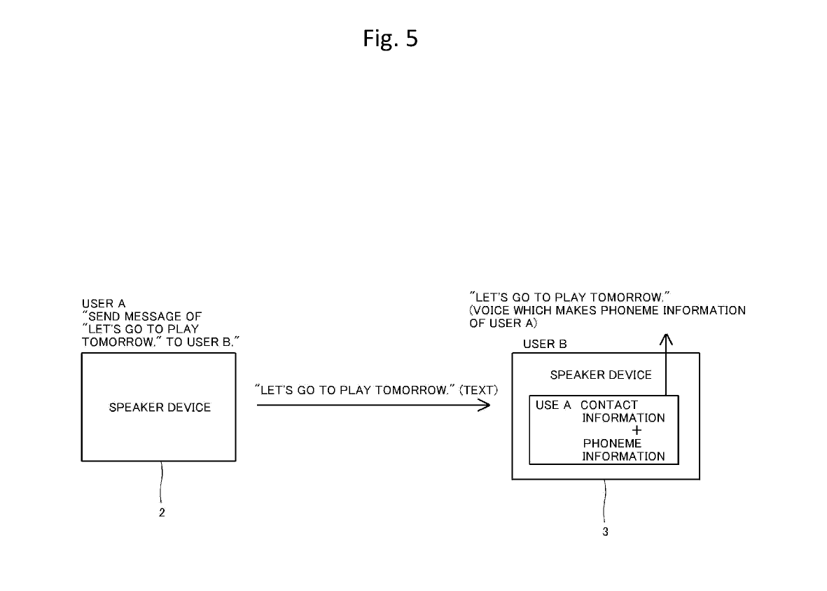

Next, as illustrated in FIG. 5, the user A speaks “Send message of ‘Let's go to play tomorrow.’ to the user B” against the speaker device 2. The SoC sends text of “Let's go to play tomorrow.” to the speaker device 3 which is owned by the user B based on the voice. When the SoC of the speaker device 3 receives the text from the speaker device 2 of the user A, the SoC reads the received text “Let's go to play tomorrow.” based on phoneme information of the user A which corresponds to contact information of the speaker device 2 of the user A. Namely, the SoC uses the phoneme information of the user A and speaks with the voice which makes use of characteristics of the user A.

As described above, in the present embodiment, when the SoC of the speaker device 3 receives text from the speaker device 2 which is the other user terminal, the SoC reads text based on phoneme information which corresponds to user contact information of the speaker device 2 of the user A. Therefore, the text is read with voice which makes use of characteristics of the user A. In this way, a user can be enjoyed. Therefore, the speech synthesis system 1 of the present embodiment is interesting.

Further, in the present embodiment, the recorded voice data is voice data which is spoken against the speaker device 2 in voice recognition. For this reason, the user does not need to speak to store phoneme information in the speech synthesis system 1.

The embodiment of the present disclosure is described above, but the mode to which the present disclosure is applicable is not limited to the above embodiment and can be suitably varied without departing from the scope of the present disclosure as illustrated below.

In the above described embodiment, as a user terminal, the speaker devices 2 and 3 are illustrated. Not limited to this, a user terminal may be a smartphone or the like.

The present disclosure can be suitably employed in a speech synthesis system which performs speech synthesis system.

What is claimed is:

1. A speech synthesis system configured to:
obtain phoneme information from recorded voice data; and
store the obtained phoneme information and user contact information in association with each other, wherein
a user terminal acquires and stores the stored phoneme information and user contact information, and
reads received text based on phoneme information which corresponds to user contact information of another user terminal when receiving text from the other user terminal.

2. The speech synthesis system according to claim 1,
wherein the recorded voice data is voice data which is spoken against the user terminal in voice recognition.

3. The speech synthesis system according to claim 1,
further configured to store multiple phoneme information and user contact information in association with each other, wherein
the multiple phoneme information and user contact information are stored in multiple user terminals and shared by the multiple user terminals.
